(19) United States
(12) Patent Application Publication
(10) Pub. No.: US 2006/0018797 A1
(43) Pub. Date: Jan. 26, 2006

(54) Microfluidic separation of particles from fluid

(75) Inventors: Simon Burnell, Bedford (GB); Victor Manneh, Bedford (GB)

Correspondence Address: FOLEY HOAG, LLP;PATENT GROUP, WORLD TRADE CENTER WEST, 155 SEAPORT BLVD, BOSTON, MA, 02110, US

(73) Assignee: Inverness Medical Switzerland GmbH, Zug (CH)

(21) Appl. No.: 11/015,311

(22) Filed: Dec. 17, 2004

Related U.S. Application Data
(60) Provisional application No. 60/553,275, filed on Mar. 15, 2004.

(30) Foreign Application Priority Data
Dec. 17, 2003 (GB) 0329220.8

(51) Int. Cl. B01L 3/02; G01N 27/447; B01L 11/00; G01N 27/26

(52) U.S. Cl. 422/100; 204/451; 204/601; 422/101

(57) ABSTRACT

A microfluidic separation system for separating fluid sample medium from cells provided in a sample, for example, a sample of bodily fluid which is to be subjected to further analysis. The system may include a microfluidic structure and a cell aggregation agent. The microfluidic structure may include one or more microfluidic channels operable to separate aggregated cells from fluid sample medium by size exclusion.

### CROSS-REFERENCE TO RELATED APPLICATIONS

This application claims the benefit of U.S. Provisional Application Ser. No. 60/553,275, filed Mar. 15, 2004, hereby incorporated herein by reference. This application also claims the right of priority to UK Patent Application Ser. No. 0329220.8, filed Dec. 17, 2003, hereby incorporated herein by reference.

### BACKGROUND

Diagnostic assay devices for the measurement of the presence and/or amount of analytes present in a fluid sample have been developed for use at the point of care or in the home setting. Such devices may be used by the healthcare professional or non-specialist personnel alike, such as the patient for self-monitoring. Consequently, such devices are designed to be easy to use, to require small volumes of fluid sample and perform the measurement rapidly. Small volume samples are desirable as they may be less painful to collect from the patient, for example when obtaining a sample of capillary blood by application of a lancet or finger-stick to the skin. Typically it will be a one-step device, the user having simply to apply a fluid sample to the device without the need to perform any further sample manipulation steps in order to obtain a result. Such systems will typically be portable and have minimal or no moving parts. Typically, a microfluidic channel or a porous carrier is employed to move sample into and/or through the device by capillary action avoiding the need to actively move the fluid sample within the device.

When performing a diagnostic assay measurement on a fluid sample, it may be desirable or necessary to remove components from the sample that may interfere with the assay. For example, it may be necessary to remove red-blood cells from whole blood where the testing regimen requires a sample or plasma. Red-blood cells may also interfere with the assay measurement, for example by absorbing light of a particular wavelength. Red-blood cells are conventionally removed from whole blood by centrifugation or by allowing the red-blood cells to settle. However such methods are ill-suited for the purposes of conducting a rapid diagnostic assay on a fluid sample of a volume ranging from typically 100 μl to less than 1 μl.

Particles may be separated from a fluid medium by using a filter such as a non-woven fabric with the appropriate pore-size. However, for the purposes of red-blood cell separation from whole blood, the use of such a filter is inappropriate, due to the tendency of the filter to block, which results in low yields of plasma filtrate. Also, the time for plasma yield to take place increases.

### SUMMARY

A microfluidic device that may be reliant only on capillary forces to drive a fluid sample can provide an effective way to separate particles from fluid. This disclosure describes systems and methods for separation that can result in rapid separation of small volumes of sample, with high levels of yield.

In an embodiment, a microfluidic separation system for separating fluid sample medium from cells provided in a sample may include a microfluidic structure and a cell aggregation agent, the microfluidic structure including one or more microfluidic channels operable to separate aggregated cells from fluid sample medium by size exclusion.

### BRIEF DESCRIPTION OF THE DRAWINGS

The following embodiments are described by way of example only, and with reference to the accompanying figures, in which:

FIG. 1 illustrates a microfluidic separation system;

FIG. 2 illustrates an assay incorporating a microfluidic separation system;

FIGS. 3A-D illustrate further the assay system of FIG. 2: FIG. 3A is a plan view of the system; FIG. 3B is a cross section taken along line X-X in FIG. 3A; FIG. 3C is an enlargement of the region A in FIG. 3B; and FIG. 3D is an enlargement of the region B in FIG. 3C;

FIGS. 4A-B further illustrate the microfluidic separation system in the assay system of FIGS. 2 and 3A-D: FIG. 4A is a perspective view of the system; and FIG. 4B is an enlargement of the region A illustrating the microstructures;

FIGS. 5A-B illustrate a further assay system in which an alternative microfluidic separation system is provided: FIG. 5A is a perspective view of the assay system; and FIG. 5B is an enlargement of the region A illustrating the separation system;

FIGS. 6A-D provide further illustrations of the alternative separation system in FIGS. 5A-B: FIG. 6A is a plan view of the assay system of FIGS. 5A-B; FIG. 6B is a cross section taken along line X-X in FIG. 6A; FIG. 6C an enlargement of the region A in FIG. 6B; and FIG. 6D is an enlargement of the region B in FIG. 6A illustrating the separation system;

FIGS. 7A-B illustrate an assay system;

FIG. 8 illustrates the sensitivity of the assay system;

FIG. 9 also illustrates the sensitivity of the assay system; and

FIG. 10 illustrates a standard curve relating to the assay system.

### DETAILED DESCRIPTION

The present disclosure relates to a microfluidic separation system for separating particles from a fluid sample, and to an assay system for detecting the amount and/or presence of an analyte in a fluid sample, or for the determination of a property of a fluid sample. In particular this disclosure relates to the separation of cells from a sample, for example the separation of red blood cells from a sample of whole blood.

The term aggregation agent is intended to encompass a wide variety of agents that can cause aggregation and/or agglutination of cells, as well as agents that can cause rosetting of cells such as red blood cells and/or promote the formation of roleaux in cells such as red blood cells.

The provision of an aggregation agent causes cells in the sample to aggregate together thereby assisting the separation of the sample medium from cells. The aggregation agent may be provided adjacent to or remote to the microfluidic structure. The aggregation agent may be mixed with a reagent that aids its release from an internal surface of the microfluidic system into the fluid sample. A plurality of aggregation agents may be provided.

The microfluidic structure may include a size exclusion element having one or more size exclusion spacings which enable the aggregated cells to be filtered from the sample medium. The size exclusion spacing thereby enables the microfluidic channels to separate aggregated cells from fluid sample medium. The size of the exclusion spacing may be chosen from any suitable size that enables aggregated cells to be separated or substantially separated from the sample medium and will be determined upon the dimensions of the system, the amount of time that the aggregation agent interacts with the fluid sample and the nature of the sample itself. A suitable size of exclusion spacing may be determined by routine experimentation. The optimum sizes of exclusion spacings may be determined on the basis of the efficiency of aggregate separation and are also most easily determined by routine experimentation. Where a plurality of size exclusion spacings are used, they may be of the same size or of differing sizes. The upper limit of the exclusion spacings will be determined by the size of the aggregates and the lower limit determined by the speed and efficiency of separation.

The microfluidic structure may define a capillary pathway. The capillary pathway may define one or more size exclusion spacings to separate aggregated cells from fluid sample medium.

The dimensions of the microfluidic channel(s) of the microfluidic structure may correspond to a size exclusion spacing. The microfluidic channel(s) may be of a dimension which varies to define the size exclusion spacing. The microfluidic channel(s) may be in fluidic communication with other microfluidic channels of different or varying dimensions.

The microfluidic structure may include at least one first microfluidic channel, the at least one first channel having a base with extending side walls, the channel being in fluid communication along a longitudinal side thereof with one or more passages having a depth less than the depth of the channel, the depth of the passage defining a size exclusion spacing.

The depth of the passage(s) defining the size exclusion spacing is such that sample medium, can pass into the passage from the first channel. Therefore aggregated cells can be separated from the sample medium by size exclusion.

The passage(s) may be in further fluid communication with a further microfluidic channel. Therefore the passage(s) may operate as a connecting region between the first and further channels which defines a size exclusion spacing. The passage(s) may be provided with one or more step formations to vary the size exclusion spacing. The step formation(s) may provide the passage with a size exclusion spacing.

The passage(s) and/or further channel(s) may be in fluid communication with a sample medium collecting region, wherein the sample medium separated from aggregated cells flows to said collecting region. The collecting region may be a further conduit or may include a chamber in the microfluidic structure.

Alternatively, the capillary pathway may include one or more microfluidic channels in which is provided one or more microstructures that define gaps corresponding to the desired size exclusion spacing(s). The microstructures may be configured to separate aggregated cells from the sample. The microstructures may define size exclusion spacings in the region of about 1 μm to about 50 μm. A plurality of groups of microstructures may be provided of the same size or of different sizes and may be arranged in any particular configuration with respect to each other. Each group may define size exclusion spacings different to other group(s). The groups of microstructures may be in an ordered configuration so that the sample flows through the group defining larger size exclusion spacings before flowing through the group(s) having smaller size exclusion spacings, wherein the sample medium is separated from aggregated cells. A collecting region may be provided downstream of the microstructures, the sample medium flowing to the collecting region after flowing through the size exclusion spacings and being separated.

The microstructures may be in the form of grooved surfaces, pillars, or any form that defines size exclusion spacings.

The dimensions of the size exclusion spacing(s) in the capillary pathway may be less than or equal to about 501 μm, less than or equal to about 40 μm, less than or equal to about 30 μm, less than or equal to about 20 μm, less than or equal to about 15 μm, less than or equal to about 10 μm, less than or equal to about 5 μm, or may be less than or equal to about 2 μm.

The capillary pathway may define a tortuous path.

The system may further include a conduit in fluid communication with the microfluidic structure to supply the microfluidic structure with the sample. The supply conduit may also supply the aggregation agent to the microfluidic structure. The aggregation agent may be provided on one or more surfaces of the conduit and/or to one or more surfaces of the capillary pathway of the microfluidic structure upstream of the size exclusion spacing(s).

The conduit may have a Reynolds number of less than 3000. Alternatively the conduit may have a Reynolds number of less than 100. The conduit is preferably a capillary. Reynolds number can be calculated using the formula:
Rₑ=ρVd/η
where Rₑ=Reynolds number, ρ₌Fluid density, V=Fluid velocity, d=length scale, and η=dynamic density. A Reynolds number of 2000 or less will cause the conduit (which may be considered to be a microstructure or microchannel) to be filled passively by surface tension (capillarity) alone.

The sample may be applied to the conduit. The sample may be applied via a sample inlet port in fluidic connection with the conduit.

Suitable non-limiting examples of aggregation agents are those that cause aggregation of red blood cells, such as dextran. Alternatively the aggregation agent may cause agglutination of red blood cells, such as lectin. As yet a further alternative, the aggregation agent may include one or more antibodies to red blood cells. Alternatively still, the aggregation agent may promote rosetting of red blood cells, or may promote the formation of rouleaux in red blood cells.

The microfluidic system may include further microfluidic elements such as internal microstructures, time gates, fluid mixing chambers, sample collections chambers, wells, channels, baffles, constrictions, a sample application port, etc. The microfluidic elements may be of a regular or irregular shape and may be in the same plane or in different planes. The microfluidic channel(s) may be of a capillary dimension which varies along its length, and may be in fluidic communication with other microfluidic elements of different or varying capillary dimensions.

The time which a sample is allowed to interact with the aggregation agent before reaching the size exclusion spacing(s) may be influenced for example by where in the system the aggregation agent is positioned, the dimensions of the upstream fluid conduit and speed with which the fluid sample travels along the fluid conduit. Where necessary, means to ensure that the aggregation agent has interacted for a sufficiently long enough time with the fluid sample may be provided, such as a chamber or time gate which serves to slow down the rate of passage of fluid sample between the supply conduit and the size exclusion spacing(s).

Typical dimensions of the microfluidic structure elements are those having a cross-sectional dimension, such as a cross-sectional diameter, of between 0.1 and 500 μm, more typically having a cross-sectional dimension of between 1 and 100 μm. Preferably the cross-sectional dimensions are chosen to be of a size such that fluid is able to be transported along, through or into the various elements of the system by capillary action. As an alternative or in addition, fluid may be transported through one or more of the elements of the system by external forces such as by electrokinetic pumping. In such cases the cross-sectional dimension may exceed the capillary dimension.

The substrate from which the system is prepared may be any suitable such as polycarbonate. In the case where the substrate is hydrophobic, the surfaces may be treated to render them hydrophilic by methods known in the art, such as for example by treatment with an oxygen plasma. As well as providing hydrophilic surfaces, other types of reagents, immobilized or otherwise may be provided on the internal surfaces.

The system may be prepared for example by providing a planar first substrate layer onto which are provided walls which serve to define the depth of the microfluidic channels in the structure, followed by provision of a second planar substrate layer which is disposed onto the upper surfaces of the walls. Suitable adhering means such as adhesives may be used to join the various structures as appropriate. Other means of preparing the structure are for example screen-printing, or the provision of multi-laminated systems having an upper and lower laminated surface which serve as upper and lower surfaces of the system, as well as intermediate laminates having structures which serve to define the elements of the microfluidic structure.

The fluid sample medium to be separated is preferably whole blood. The system may therefore enable aggregated red blood cells to be separated from the sample medium.

The microfluidic separation system may be disposable.

According to a second aspect, there is provided an assay system for conducting an assay on a fluid sample, the assay system including a microfluidic separation system according to the first aspect in fluid communication with an analyte detection zone.

The assay system may include a sample entry port for the application of fluid sample in fluid connection with the microfluidic structure of the separation system. The detection zone may be provided downstream from the microfluidic structure, into which fluid sample may flow from the microfluidic structure after separation. Reagents either specific or non-specific to the analyte of interest may be provided within the assay system and may be provided on the inner surface of the detection zone. The assay system may further include an interferent zone that serves to neutralize or remove molecules from the sample that may interfere with the binding interactions in the assay system, or with the signal generation and detection. Yet further zones may be provided within the assay system in fluidic communication with one or more of the other zones and may include wash zones, time gates, pre-mixing zones, reaction zones and the like.

The assay may be chosen from any that is able to determine the presence and/or amount of an analyte of interest. The assay may be a binding assay, such as a specific binding assay in which a specific binding event takes place between a specific binding pair, one of the binding partners being the analyte of interest, the other being chosen from any compound or composition capable of recognizing a particular spatial or polar orientation of a molecule, e.g., epitopic or determinant site. Examples of suitable binding pairs are an antibody and antigen, biotin and avidin, carbohydrates and lectins, complementary nucleotide sequences, complementary peptide sequences, effector and receptor molecules, enzyme cofactors and enzymes, enzyme inhibitors and enzymes, a peptide sequence and an antibody specific for the sequence or the entire protein, polymeric acids and bases, dyes and protein binders, peptides and specific protein binders and so on. Where the binding partner is an antibody it may be monoclonal or polyclonal, or it may be a fragment thereof. Fragments thereof may include Fab, Fv and F(ab′)2, Fab′, and the like. The assay may involve a specific reaction which takes place between the analyte and an enzyme, Suitable enzymes are ones which employ FAD/FADH₂, NAD/NADH₂ or NADP/NADPH₂ systems.

One of the specific binding partners may be provided with a detectable label. “Label” refers to any substance that is capable of producing a signal that is detectable by visual or instrumental means. Examples of suitable labels include enzymes and substrates, chromogens, catalysts, fluorescent compounds, chemiluminescent compounds, radioactive labels as well as particulate colloidal metallic particles such as gold, or particulate dyed organic substances such as polyurethane.

The binding assay may be either heterogeneous or homogeneous.

Where the assay is homogeneous it is desirable that the label, which is attached to the specific binding partner, is able to undergo some detectable physical or chemical change upon binding to form a specific binding pair such that the bound species may be distinguished from the unbound species. Examples of such binding assays which involve an energy transfer or result in a change in wavelength are given in U.S. Pat. No. 5,705,622 and U.S. Pat. No. 6,215,560.

The sample medium of interest may be whole blood, but may be chosen from any sample medium where separation of particulate matter that is able to be aggregated by a aggregation agent is required, such as white blood cells.

Analytes of interest include, but are not limited to, toxins, organic compounds, proteins, peptides, microorganisms, bacteria, viruses, amino acids, nucleic acids, carbohydrates, hormones, steroids, vitamins, drugs of abuse, pollutants, pesticides, and metabolites of or antibodies to any of the above substances. Specific examples thereof are specific cardiac markers including troponin T and troponin I, CKMB, C-reactive protein (CRP), natriuretic peptides such as ANP and BNP as well as their N-terminal fragments. Other analytes of interest include human chorionic gonadotrophin (hCG), luteinizing hormone (LH) and follicle stimulating hormone (FSH) as well as markers of bone resorption.

The assay may be a binding assay, which has an optical emission and may be a luminescent oxygen channeling immunoassay. Such an immunoassay can include at least:
a. donor particles able to generate singlet oxygen when irradiated with light;
b. acceptor particles containing emission means activated by the singlet oxygen to emit detectable light;
c. the donor and acceptor particles being adapted to recognize and bind to the analyte, wherein on binding of both the donor and acceptor particles to the analyte, generated singlet oxygen activates the emission means on the acceptor particles to emit detectable light; and
d. a detector to detect light emitted by the acceptor particle.

The donor and acceptor particles recognize the analyte through antibodies provided on the surfaces of the particles. The emission means may include a dissolved dye that can be activated by the singlet oxygen to produce chemiluminescent emission. The chemiluminescent emission activates fluorophores in the acceptor particle causing emission of light. The light may be emitted at 520-620 nm. Singlet oxygen may be emitted when irradiated with light of wavelength 680 nm. The donor particles may include dissolved phthalocyanine, the phthalocyanine generating the singlet oxygen when irradiated.

The assay system may further include a transduction system. The transduction system may be optical, magnetic, electrochemical, radiological or may involve measurement of a change of mass, frequency or energy state, depending upon the signal of interest to be detected. Where the signal is an optical one, it may be of any particular detectable wavelength or wavelength range and includes fluorescent and chemiluminescent signals.

The assay system may alternatively or in addition be used to determine a particular property of a fluid sample such as the coagulation time or prothrombin time.

The detection zone may include a microfluidic channel or may include a well. Detection means may be provided as an integral part of the detection zone. An excitation means may also be integrally provided as part of this zone. Examples of an excitation means and a detection means are respectively a light emitting diode and a photodetector. There may be one of more detection zones and one or more excitation and detector means. The detector means and excitation means may be chosen to be a size and shape as is convenient and will preferably be chosen such as to maximize the capture efficiency of the signal to be measured. The excitation means and detector means will typically be located on a surface exterior to the fluid sample in the vicinity of the detection zone.

The substrate of the detection zone may be chosen from any suitable material or materials depending upon the purpose. Examples of suitable substrates are plastics such as polycarbonate. In the region of the detection zone where the signal to be detected is an optical signal, the substrate may chosen from one that is able to transmit the optical signal such as a suitable optically transparent plastics material.

Additionally or alternatively the plastics material may incorporate a filter to remove light of undesired wavelength. As yet a further alternative, the filter may be present on a surface of the assay substrate. The optically transparent substrate may also be a lens, either converging or diverging onto which an excitation source or detector may be positioned. Light may then be either converged or diverged as desired. The substrate may also be partially transparent or have a surface roughness thus allowing for a diffuse source of light.

The assay system may be configured so that the sample flows into the assay detection zone after the interferent zone. The interferent zone may include one or more agents to influence the pH of the fluid sample or to remove or solubilize particular species such as lipids by for example solubilizing them with surfactants, or by selectively binding them with a lipid-binding agent. The interferent zone may be time-gated so that only fully treated sample passes into the assay.

The assay system may measure analyte levels in bodily fluid which may be whole blood. Plasma may have been separated from aggregated red blood cells by the microfluidic separation system of the assay system.

The assay system may be disposable and may be designed to be used in combination with a meter that is able to display the results of the assay. The meter may include a display, a power source, and the appropriate circuitry. The meter may also include a light source and detector. Alternatively the assay system and meter may be wholly integrated into a disposable system. The assay system may be integrated with a fluid sampling and collection system such as a lancet, such that transfer of sample from the site of collection to the assay system may be avoided.

According to a further aspect, there is provided a method of separating fluid sample medium from cells provided in a fluid sample, including applying a fluid sample to a microfluidic separation system described herein.

A sample of less than or equal to 100 μl may be applied.

The method may be for separating plasma from red blood cells in whole blood.

The sample may be mixed with a cell aggregation agent before addition to the microfluidic structure of the microfluidic separation system.

According to a further aspect, there is provided a method of detecting an analyte in a fluid sample, the method including applying a fluid sample to an assay system described herein.

The sample may be mixed with a cell aggregation agent before addition to the microfluidic structure of the microfluidic separation system. Preferred features of each aspect are as for each other aspect mutatis mutandis.

Exemplary embodiments include a microfluidic separation system for separating sample medium from cells, an assay system for detecting and measuring an analyte in a sample, and/or for measuring analyte in a sample.

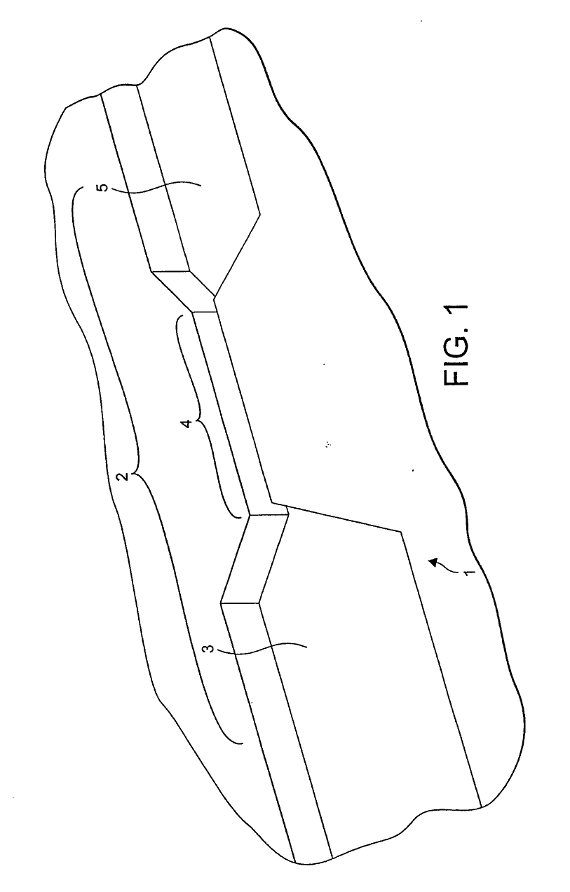

One exemplary microfluidic separation system 1 is illustrated in FIG. 1. The system 1 includes a microfluidic structure 2 and a cell aggregation agent (not shown). The microfluidic structure 2 defines a capillary pathway. The capillary pathway includes a channel 3. The dimensions of the channel 3 varies along the length thereof. In particular at region 4 the channel narrows to provide a size exclusion spacing having dimensions less than 10 μm. This size exclusion spacing is designed to prevent cells aggregated by the aggregation agent from flowing further downstream from this region 4. The aggregation agent can be provided in the channel 3 upstream of the size exclusion spacing or may be applied to the sample before the sample is applied to the microfluidic structure 2. Alternatively the aggregation agent can be immobilized onto one or more surfaces of the channel upstream of the size exclusion spacing. The channel widens at region 5 to provide a sample collecting region into which sample medium without cells can flow. The system is also provided with a lid (not shown) defining an upper surface of the channel 3. The sample flows through the capillary pathway by capillary forces. To assist this flow, the surfaces of the capillary pathway are coated with a hydrophilic coating.

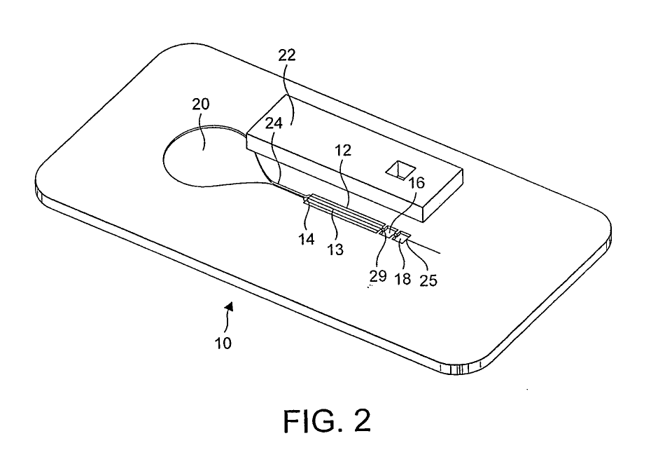

FIG. 2 of the accompanying drawings illustrates an exemplary assay system 10. The system 10 incorporates a microfluidic separation system 12 and an assay detection zone 18. The system 10 also includes an interferent zone 14, a pre-treatment zone 16, and a sample application region 20. The assay system 10 is for use in the detection of an analyte in a sample applied to the system. A sample of less than 100 μl can be applied to the region 20 before flowing down a conduit 24 towards the microfluidic separation system 12. The conduit 24 can be a microchannel and could have a Reynolds number of less than 3000, or less than 100 (in the case of a capillary). The sample flows passively by capillary action, or actively through the application of a pressure differential to the system 10. The assay system 10 is arranged so that the sample travels uni-directionally.

The microfluidic separation system 12 may include a microfluidic structure 13 defining a capillary pathway. The structure is arranged to separate sample medium from cells provided in the sample by size exclusion. Before the sample passes through the structure 13, the sample is mixed with a cell aggregation agent of the system to cause aggregation of cells. The cell aggregation agent can be added to the sample before applying the sample to region 20. Alternatively the agent can be provided in the region 20, or in the conduit 24. The agent can be provided on at least one surface of the region 20 or conduit 24.

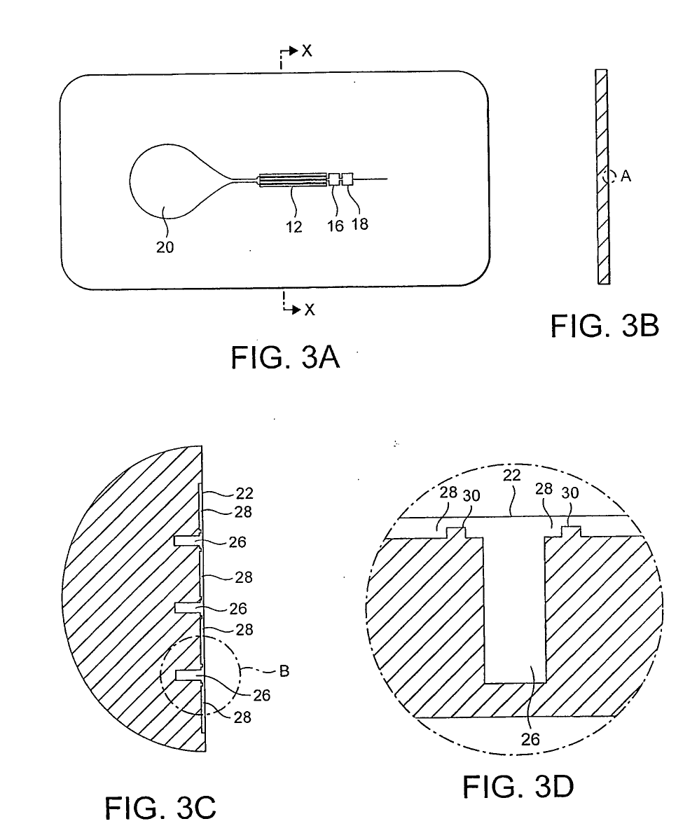

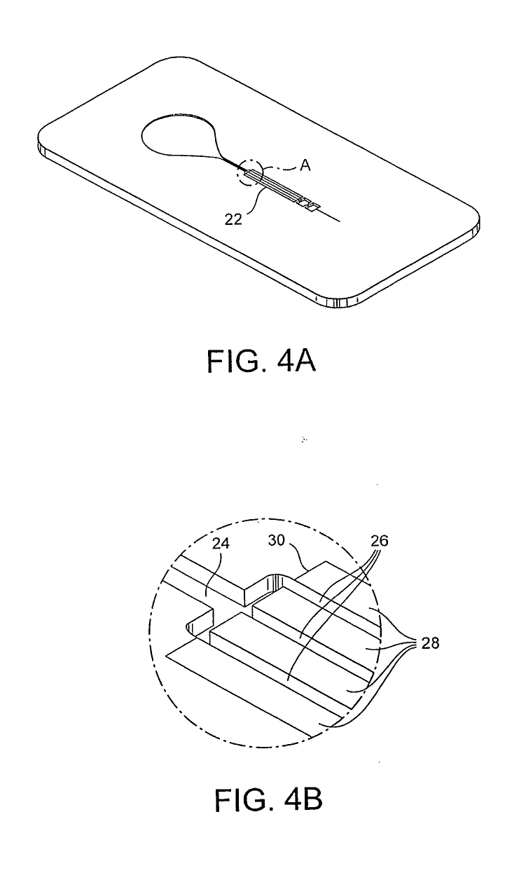

The microfluidic structure 13 is best illustrated in FIG. 3C and FIG. 4B. As can been seen the conduit 24 may split into a capillary pathway having a number of channels 26. Each of the channels 26 is in fluid communication along a longitudinal side thereof with a respective further channel in the form of a passage 28, which has a depth that is smaller than the depth of the respective channel 26. The depth of the passage 28 is configured so that aggregates of cells are unable to pass there through whereas the sample medium can, due to size exclusion. Therefore the passage depth provides a size exclusion spacing. The channels 26 and passages 28 have an upper surface defined by a lid 22 (see FIG. 3C).

The passages 28 can be provided with step formations 30 that define a shallower depth. This is illustrated in FIG. 3D. The provision of step formations 30 provides for the initial passage depth acting as a pre-filter with the step formations 30 defining a size exclusion spacing functioning as the main filter separating the sample medium from the aggregated cells. The step formations 30 can be in the form of pillars or raised surfaces.

The depth of the channels 26 is in the region of 100 μm. The depth of the passages 28 is in the region of 20 μm, with the depth provided by the step formations 30 being in the region of 10 μm.

The cell medium passing into the passages 28 is channeled towards a collecting region 29 of the capillary pathway in the microfluidic structure 13.

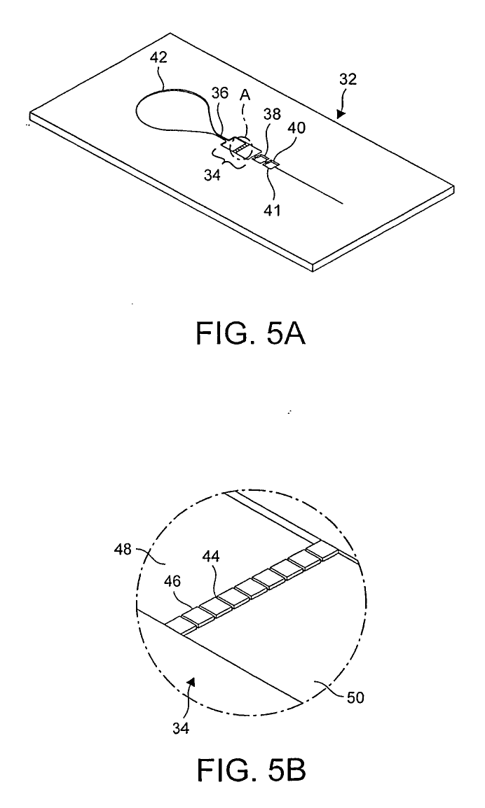

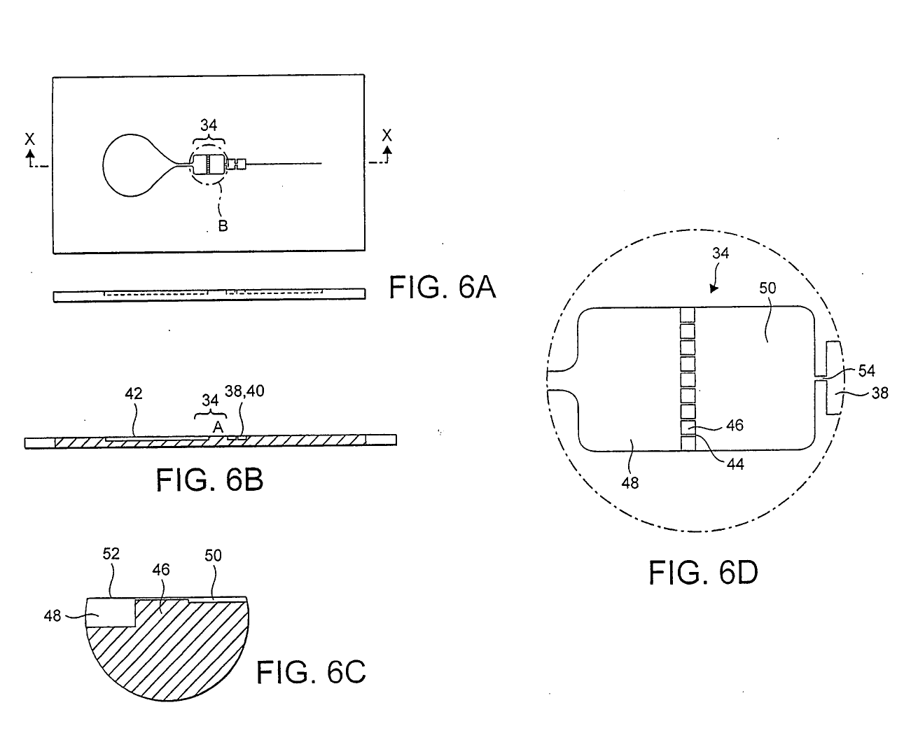

An alternative microfluidic separation system 34 is provided in the assay system 32 illustrated in FIGS. 5A-B and 6A-D. FIG. 5A provides a perspective view of the system 32. The system 32 includes an interferent zone 36, a pre-treatment zone 38, an assay system 40, and a sample application region 42.

The microfluidic separation system 34 may have a aggregation agent and also a microfluidic structure that defines a capillary pathway. The capillary pathway may include a first channel 48 in fluid communication with a second channel 50. A number of microstructures in the form of pillars 46 are provided between the channels 48, 50. The pillars 46 define a number of gaps 44. The gaps 44 may be of a size to enable sample medium to flow there through whereas aggregated cells cannot. The gaps are size exclusion spacings. The second channel 50 is provided with an outlet 54 to a pre-treatment zone 38. As with the system 10, a lid 52 can be provided.

The aggregation agent may be provided in the first channel 48 and it may be immobilized on one or more surfaces of the channel. Alternatively, the aggregation agent is contacted with the sample before the sample flows into the capillary pathway of the microfluidic structure of the separation system 34.

The channel 48 is deeper than the channel 50. Indeed the channel 48 has a depth of 100 μm and the channel 50 has a depth of between 10-20 μm. The gaps defined by the pillars 46 are in the region of 10μm.

As with the microfluidic system 10, the system can work actively (for example using a pressure differential or electrokinetic pumping),or passively (through capillary action and surface tension).

The microfluidic separation systems 1, 12, 34 described above can be used to separate plasma from red blood cells in whole blood. In this example, a whole blood sample after application flows towards the respective microfluidic structures of the separation systems 1, 12, 34 . A red blood cell aggregation agent is provided upstream of the microfluidic structures of system 1, 12, 34. Alternatively the agent can be provided in the microfluidic structure of the system 1, 12, 34 and may be immobilized onto one or more surfaces upstream of the size exclusion spacing(s). The microfluidic structures of the separation systems 1,12, 34 are configured to separate the plasma from the aggregated red blood cells using size exclusion. The size exclusion spacings defined in the structures allow the plasma to flow there through.

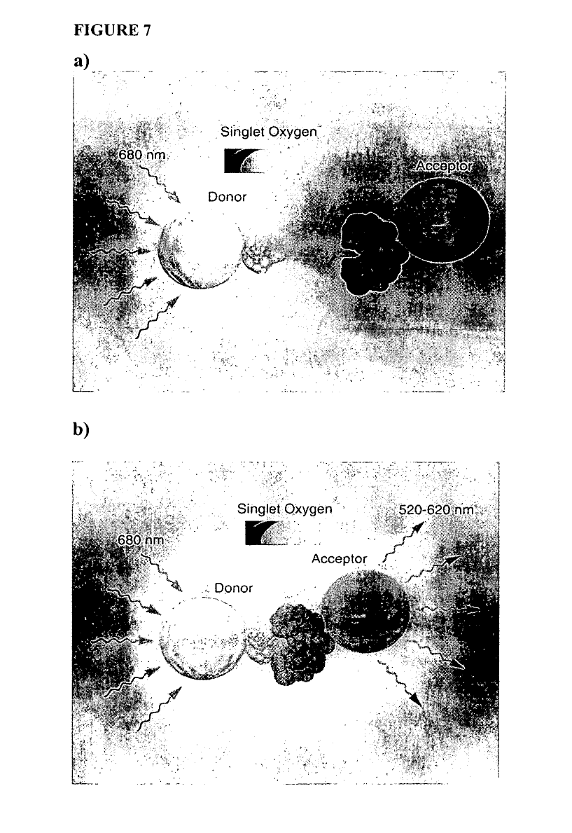

The assay systems 10, 32 may also include homogeneous assay/detection systems 24, 40 to detect and measure analyte in a sample of less than or equal to 50 μl. An example of an assay system is illustrated in FIGS. 7A-B. This system depends on a combination of latex agglutination and chemi-luminescent signal. In this regard, an analyte molecule brings together two beads producing a cascade of chemical reactions to greatly amplify the signal such that in principle attomolar concentrations of analyte can be detected. The system provides a highly sensitive homogenous immunoassay that takes place in a highly efficient light capturing detection chamber. Incubation of the sample with assay components is achieved through a time-gated structure.

The assay illustrated in FIGS. 7A-B is a luminescent oxygen channeling immunoassay. In more detail, photosensitizer particles (Donor particles) containing dissolved phthalocyanine generate singlet oxygen when irradiated with light of wavelength 680 nm, FIG. 7A. The singlet oxygen produced has a very short half-life, circa 4 microseconds and hence decays rapidly to a ground state. As such it can only diffuse to a distance of a few hundred microns from the surface of the particles before it decays to ground state. However, it can survive long enough to enter any paired adjacent particle, FIG. 7B. The paired adjacent particles (acceptor particles) contain a dissolved dye that is activated by the singlet oxygen received to produce chemiluminescent emission. This chemiluminescent emission activates further fluorophores contained in the same bead, subsequently causing emission of light at 520-620 nm. The reagents can be lyophilized in a well with an optimized geometry and low optical absorbance to ensure maximum excitation and light capturing efficiency. The donor and acceptor particles can recognize the analyte through antibodies provided on the surfaces of the particles, such that the particles are brought together by the analyte.

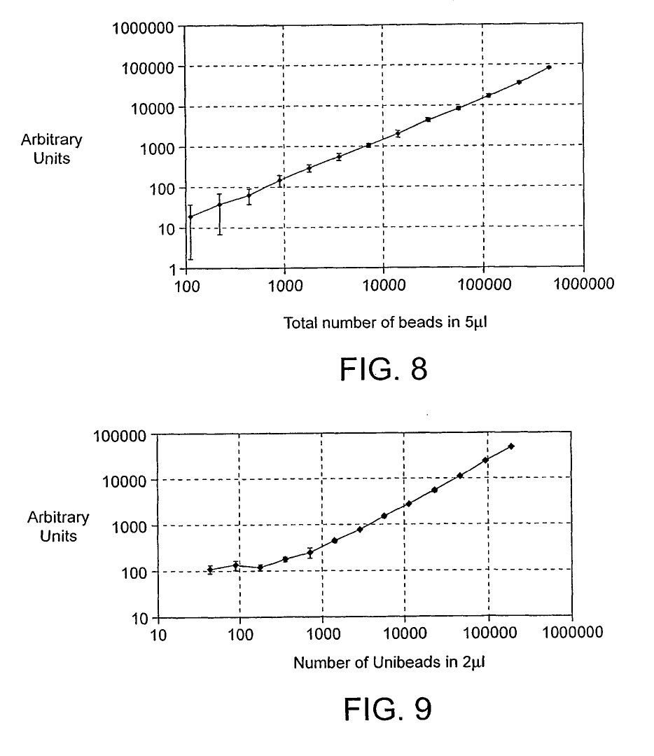

The sensitivity of detection of the assay was determined in two ways, FIG. 8 and FIG. 9. A first experiment in a 384 well microtiter plate, FIG. 8, demonstrated the linear behavior between the total number of Unibeads and assay output signal. Unibeads are a pre-conjugated single bead that incorporates both the acceptor and donor particles. As such the quantum efficiency of the transfer of the singlet oxygen can be neglected due to the proximity of the particles. In this experiment the total number of beads was varied from 100 to 100000.

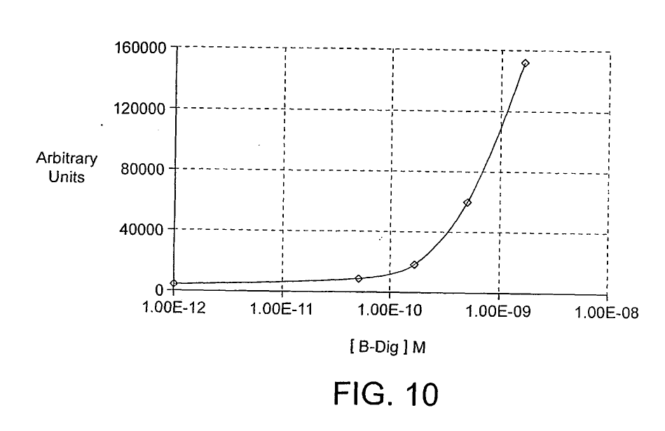

In FIG. 9, reducing the volume to that likely to be used in the final chip configuration, 2 μl, the signal can be seen to flattens off as the concentration is reduced. This is due to the auto-fluorescence of the unibeads. The minimum number of particles that can be reliably detected is approximately 400 in 2 μl of sample. In developing the assay, FIG. 10, a standard curve obtained from a biotinylated—DIG assay using 384 microtiter plate with 25 μl assay volume was obtained.

A sensitive homogeneous assay has been successfully designed and manufactured based on a micro fluidic system. The assay has been successfully transferred from a microtiter plate to a chip format and has generated a dose response curve whereby analyte at a concentration of 1.6×10⁻¹⁰ molar can be detected in 2 μl of plasma.

The assay system does not necessarily have to be in a form of a luminescent oxygen channeling immunoassay.

As discussed above the assay systems 10, 32 may also include an interference zone 14, 36 for solid phase extraction of molecules that can interfere with the binding interactions in the detection zones 18, 40, or with a signal generation and detection. The interferent zone 14, 36, may be provided before the sample encounters the cell separation system 12, 34, or before the sample flows into the assay detection zone 25, 41. The zone 14, 36 includes a number of agents to neutralize or remove molecules from the sample. The interferent zones 14, 36 can be time gated to ensure that only fully treated sample passes into the assay system 18, 40.

### EXAMPLE

A sample of whole blood from a human patient (45% hematocrit) was drawn into an EDTA tube and 4 μl of the blood sample was mixed in a ratio of 1:1 with 2 μl of Lectin PHA-E (Sigma) dissolved in phosphate buffer solution (PBS) at a concentration of 5 mgs/ml. The sample was subsequently incubated at room temperature for 1 minute to allow the red-blood cells to agglomerate prior to application to the microfluidic separation system described above with reference to FIGS. 2, 3A-D, and 4A-B.

The conduit 24 has dimensions of 200 μm (width) by 100 μm (height). The system was prepared from a polycarbonate substrate by injection molding of a base substrate to form the base or lower part of the device as well as the microfluidic elements followed by ultrasonic welding of a one-piece injection molded substrate to the base substrate to form the lid or upper surface of the system. Prior to assembly, the substrates were treated with an oxygen plasma to render the surfaces hydrophilic. The degree of hydrophilicity of the surfaces was measured and the surface contact angle found to be 20 degrees.

Fluid sample (4 μ) was applied to the sample application region 20 and subsequently moved towards the microfluidic structure 13. The agglomerated cells were substantially unable to pass through the microfluidic structure thus resulting in separation of the plasma/buffer filtrate from the agglomerated red cells.

The total plasma/ buffer extracted was 200 nl in a time of less than 10 minutes. The efficiency of the plasma separation was calculated as being 11% of the total available plasma.

All publications and patents mentioned herein are hereby incorporated by reference in their entirety as if each individual publication or patent were specifically and individually indicated to be incorporated by reference.

1. A microfluidic separation system for separating fluid sample medium from cells provided in a sample, the system comprising a microfluidic structure and a cell aggregation agent, the microfluidic structure comprising one or more microfluidic channels operable to separate aggregated cells from fluid sample medium by size exclusion.

2. A system as defined by claim 1, wherein the microfluidic structure defines a capillary pathway.

3. A system as defined by claim 2, wherein the capillary pathway comprises at least one first microfluidic channel, the at least one first channel having a base with extending side walls, the channel being in fluid communication along a longitudinal side thereof with one or more passages having a depth less than the depth of the channel, the depth of the passage defining a size exclusion spacing.

4. A system as defined by claim 3, wherein the one or more passages is in further fluid communication with a further microfluidic channel.

5. A system as defined by claim 3, wherein the one or more passages are provided with one or more step formations to vary the size exclusion spacing.

6. A system as defined by claim 3, wherein the one or more passages and/or further channel are in fluid communication with a sample medium collecting region, wherein the sample medium separated from aggregated cells flows to said collecting region.

7. A system as defined by claim 2, wherein the capillary pathway comprises one or more microfluidic channels in which is provided one or more microstructures that define gaps corresponding to the desired size exclusion spacing or spacings.

8. A system as defined by claim 7, wherein a plurality of groups of microstructures is provided.

9. A system as defined by claim 8, wherein at least some groups define size exclusion spacings different from one another.

10. A system as defined by claim 8, wherein the groups of microstructures are in an ordered configuration so that the sample flows through a group defining larger size exclusion spacings before flowing through a group having smaller size exclusion spacings, whereby the sample medium is separated from aggregated cells.

11. A system as defined by claim 7, wherein a collecting region is provided downstream of the microstructures, the sample medium flowing to the collecting region after flowing through the size exclusion spacings and being separated.

12. A system as defined by claim 2, wherein the capillary pathway defines one or more size exclusion spacings to separate aggregated cells from fluid sample medium.

13. A system as defined by claim 2, wherein the aggregation agent is provided on one or more surfaces of the capillary pathway.

14. A system as defined by claim 1, wherein the microfluidic structure comprises a size exclusion element having one or more size exclusion spacings.

15. A system as defined by claim 14, wherein the size exclusion element defines one or more size exclusion spacings to separate aggregated cells from fluid sample medium.

16. A system as defined by claim 15, wherein the dimensions of the size exclusion spacing(s) in the capillary pathway are less than or equal to about 50 μm, less than or equal to about 40 μm, less than or equal to about 30 μm, less than or equal to about 20 μm, less than or equal to about 15 μm, less than or equal to about 10 μm, less than or equal to about 5 μm, or less than or equal to about 2 μm.

17. A system as defined by claim 15, wherein the one or more microfluidic channels vary in dimension along their lengths.

18. A system as defined by claim 1, wherein the one or more microfluidic channels are in fluidic communication with other microfluidic channels of different or varying dimensions.

19. A system as defined by claim 1, further comprising a conduit in fluid communication with the microfluidic structure, wherein the aggregation agent is provided on one or more surfaces of the conduit.

20. A system as defined by claim 1, wherein the aggregation agent comprises dextran or lectin.

21. An assay system for conducting an assay on a fluid sample, the assay system comprising a microfluidic separation system according to claim 1 in fluid communication with an analyte detection zone.

22. An assay system as defined by claim 21, wherein the assay system comprises a sample entry port for the application of fluid sample in fluid connection with the microfluidic structure of the separation system.

23. An assay system as defined by claim 21, wherein the detection zone is provided downstream from the microfluidic structure, into which fluid sample flows from the microfluidic structure after separation.

24. An assay system as defined by claim 23, wherein reagents either specific or non-specific to the analyte of interest are provided within the assay system and are provided on an inner surface of the detection zone.

25. An assay system as defined by claim 24, wherein the assay system further comprises an interferent zone that serves to neutralize or remove molecules from the sample that may interfere with the binding interactions in the assay system, or with the signal generation and detection.

26. An assay system as defined by claim 21, further comprising a transduction system.

27. A method of separating fluid sample medium from cells provided in a fluid sample, comprising applying a fluid sample to a microfluidic separation system as defined by claim 1.

28. A method as defined by claim 27, further comprising mixing the sample with a cell aggregation agent before applying the sample to the microfluidic structure.

29. A method of detecting an analyte in a fluid sample, comprising applying a fluid sample to an assay system as defined by claim 21, and performing an assay on the sample.

30. A method as defined by claim 29, further comprising mixing the sample with a cell aggregation agent before the sample contacts the microfluidic structure.
